(19) United States
(12) Patent Application Publication
(10) Pub. No.: US 2013/0290882 A1
(43) Pub. Date: Oct. 31, 2013

(54) METHOD AND APPARATUS FOR DISPLAYING A GRAPHICAL USER INTERFACE OF A PORTABLE COMPUTATION UNIT ON AN EXTERNAL DISPLAY UNIT

(71) Applicant: Pierre-Alain Cotte, Amberg (DE)

(72) Inventor: Pierre-Alain Cotte, Amberg (DE)

(21) Appl. No.: 13/988,787

(22) PCT Filed: Nov. 22, 2011
(86) PCT No.: PCT/EP2011/005883

§ 371 Date: Jul. 16, 2013

(30) Foreign Application Priority Data
Nov. 23, 2010 (DE) 10 2010 052 244.9

(51) Int. Cl. G06F 3/048

(52) U.S. Cl. CPC G06F 3/048
USPC 715/764

(57) ABSTRACT

A method displays a graphical user interface of a portable computation unit on an external display unit, which has a native resolution and a native aspect ratio. An operating system of the portable computation unit is emulated on an external computation unit in an emulation. Input of user inputs is received into the portable computation unit and transmitted to the emulations. The user inputs are interpreted in the emulation. An emulated user interface of the portable computation unit is produced. The emulated user interface is transmitted in the form of graphics data to the external display unit and displayed on the external display unit.

### CROSS REFERENCE TO RELATED APPLICATIONS

This application is a U.S. National Phase application under 35 U.S.C. §371 of International Application No. PCT/EP2011/005883, filed on Nov. 22, 2011, and claims benefit to German Patent Application No. DE 10 2010 052 244.9, filed on Nov. 23, 2010. The International Application was published in German on May 31, 2012, as WO 2012/069183 A1 under PCT Article 21 (2).

### FIELD

The invention relates to a method and an apparatus for displaying a graphical user interface of a portable computation unit on a display unit. The method and the apparatus provide a remedy for a problem that is known to many: the screen and the contents of a portable computation unit displayed upon it are too small. This problem manifests itself in particular with smartphones, which are becoming increasingly popular.

### BACKGROUND

It is possible in the state of the art to connect the smartphone by cable to a larger screen. This has the disadvantage that a cable is required. Furthermore, it is necessary for this that the option of an external display has already been provided by the manufacturer. Moreover, a larger display requires more computing power and a portable computation unit cannot usually provide this.

In the state of the art, it is possible to execute software on a smartphone that permits logging into the smartphone from another computer via a network and having the graphical interface of the smartphone displayed. It is disadvantageous in this case that the graphics data must be exchanged between the smartphone and the other computer, and this necessitates a high available transmission bandwidth. Logging in from the other computer is also very laborious for the user of the smartphone. It is also disadvantageous that the user interface of the smartphone is only displayed on the large screen in the resolution in which it is displayed on the smartphone. It is not possible, therefore, to combine an enlargement of the graphical output with a genuine gain in resolution and thus more picture information.

### SUMMARY

In an embodiment, the present invention provides a method for displaying a graphical user interface of a portable computation unit on an external display unit, which has a native resolution and a native aspect ratio. An operating system of the portable computation unit is emulated on an external computation unit in an emulation. Input of user inputs is received into the portable computation unit and transmitted to the emulations. The user inputs are interpreted in the emulation. An emulated user interface of the portable computation unit is produced. The emulated user interface is transmitted in the form of graphics data to the external display unit and displayed on the external display unit.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an overview and visualization of a method according to the invention as well as of the apparatus, wherein the graphical interface of a smartphone is shown enlarged on a television unit,

FIG. 2 shows an overview and visualization of a method according to the invention as well as of the apparatus, wherein a user makes user inputs into the external display unit and these control both the emulation and the portable computation unit,

FIG. 3 shows an overview and visualization similar to that of FIG. 2 with the difference that wireless communication is used between the external display unit and the external computation unit and in addition the external computation unit is connected to a software source,

FIG. 4 shows an overview and visualization similar to that of FIG. 3, wherein the input interfaces and the graphical interface are spatially separated from the external computation unit and communicate with the external computation unit via network interfaces and wherein the operating system of a further portable computation unit is emulated and the emulated user interface is displayed.

### DETAILED DESCRIPTION

An aspect of the present invention is to improve the disadvantages of the state of the art.

In an embodiment, the present invention provides a method for displaying a graphical user interface of a portable computation unit (20) on an external display unit (40), which has a native resolution and a native aspect ratio, wherein the steps are carried out:
emulation of an operating system of the portable computation unit (20) on an external computation unit (60) in an emulation (70);
input of user inputs (80) into the portable computation unit (20);
transmission of the user inputs (80) to the emulation (70);
interpretation of the user inputs (80) in the emulation (70);
production of an emulated user interface (55) of the portable computation unit (20);
transmission of the emulated user interface (55) in the form of graphics data (50) to the external display unit (40);
display of the emulated user interface (55) on the external display unit (40).

A graphical user interface is preferably a display of manipulation options of data and/or functions (e.g. programs) of a computation unit that can be displayed on a screen and/or a display of information that can be displayed on a screen. According to the invention, this can be both the graphical user interface of the operating system of the computation unit and the graphical user interface of a program that is executed in the operating system, or parts of a program or of an operating system, namely graphical elements for visualising data and/or manipulation options (e.g. documents, drawings, texts, videos, buttons, etc.). It is preferably the graphical user interface of the operating system of the computation unit. A graphical user interface is preferably constructed from graphical elements (e.g. windows, buttons, text, images, graphics, icons, desktop background picture).

The portable computation unit is e.g. a smartphone, a tablet computer or a personal digital assistant (PDA). Portable preferably means that the computation unit is such with regard to its weight and dimensions that it can easily be carried in a briefcase, preferably a trouser or jacket pocket.

The operating system of the portable computation unit represents preferably the interface between the hardware of the computation unit and the functions (programs, data accesses). An operating system of a portable computation unit is e.g. Linux, Windows, Mac OS, Android, Apple iOS, etc.

The graphical user interface of a portable computation unit is preferably the graphical interface between the user and the data and functions of the portable computation unit. The graphical user interface of a portable computation unit is preferably the graphical interface of a subroutine that is executed on the operating system of the portable computation unit. Different computation units have different graphical user interfaces, depending on the manufacturer of the operating system and of the programs that can be executed under this operating system (e.g. Linux, Windows, Mac OS, Android, Apple iOS, etc.).

The display of a graphical user interface is preferably the analogous, particularly preferably identical, visualization with reference to the graphical design of at least a part, preferably of all the—preferably changing—graphical elements of the user interface on a screen.

An external display unit is for example a computer monitor, an LCD/plasma television, projectors (e.g. LCD), head-up displays, head-mounted displays, preferably an LCD television.

The native resolution of the external display unit is a resolution that corresponds to the exact physical resolution (number of pixels) of the display unit. The native aspect ratio is the aspect ratio (number of pixels in width divided by number of pixels in height) that corresponds exactly to the physical aspect ratio of the display unit.

The external computation unit is a further computation unit. This is external with reference to the portable computation unit. The external computation unit is e.g. a desktop computer, PC a computation unit integrated into a set-top box, a notebook/laptop, a server, a remote server etc.

The emulation is preferably the execution of an operating system within another operating system in an emulation environment provided for this. An emulation environment is normally a program that is/will be installed on the computation unit on which the emulation is carried out. The operating system to be emulated is then preferably installed and executed within the emulation environment. The emulation of the operating system is preferably an execution of the operating system within the emulation environment. The emulation environment preferably makes available virtual hardware components of the computation unit whose operating system is emulated. For example, these are virtual input units, which are preferably controlled by the emulation environment with the result that these virtual input units behave and produce data as if they were also physically present. Such input units are e.g. sensors of the computation unit whose operating system is emulated, peripherals such as a mouse, keyboard connected to this computation unit and/or integrated peripherals such as a camera, microphone etc.

The emulation of the operating system of the portable computation unit on an external computation unit makes it possible for the operating system of the portable computation unit to be executed without the hardware of the portable computation unit being physically present in the external computation unit. In this case the selected computing architecture of the external computation unit is preferably independent of the computing architecture of the portable computation unit. Alternatively, the external computation unit preferably has a processor and/or other hardware components that correspond to the architecture of the portable computation unit. In this way the emulation is more efficient, as not all instructions to the hardware of the computation unit (e.g. adding functions) have to be translated into the instruction set of another computer architecture.

According to the invention, the following are understood as user inputs, for example: inputs via a touch-sensitive surface (touchpad), a touch-sensitive display, mouse, keyboard, movement sensor, touch sensor, scanner, data reading units, position sensor (e.g. GPS) or other inputs that can be made into a computation unit. User inputs are preferably also inputs that are made automatically by a computation unit, in which a user does not necessarily interact, therefore. For example, these are the automatic taking of pictures by a camera integrated into the computation unit, or automatic reading in of data of a data carrier connected physically or via a network to the computation unit, automated temperature measurements etc.

User inputs into the portable computation unit are aforementioned inputs that are made with the aid of the portable computation unit. These user inputs preferably call up functions within the operating system of the portable computation unit (e.g. storage of data, browsing in menus, generating of specific graphical outputs, set-up of telephone and/or network connections, etc.).

Transmission is preferably understood to be a transport of preferably data from a source to a drain, wherein preferably intermediate stations (e.g. network nodes, interfaces between programs) also lie on the transport path.

The transmission of the user inputs to the emulation is preferably a transmission of user inputs as a digital and/or analog data sequence from the portable computation unit to the emulation. The user inputs are transmitted to the emulation preferably in such a way that the data of the user inputs can be assigned to the virtual input units in the emulation. For example, header information that characterizes the type of user input is prefixed to the data sequence.

The interpretation of the user inputs in the emulation includes preferably the step/steps
assignment of the user inputs to virtual input units in the emulation and/or
calling up of functions/programs (such as e.g. storage of data, etc.) within the emulated operating system according to the type of respective user input.

By the transmission of the user inputs to the emulation and the interpretation of the user inputs in the emulation, the execution statuses of the emulation and the operating system that is executed on the portable computation unit are preferably kept substantially identical. An execution status is characterized by one or more of the following features: type and number of programs opened, position of a mouse pointer, windows and/or texts and/or graphics displayed, assignment of main memory space, type and number of peripherals connected, play status of multimedia data (presentations, videos, audio data), etc. Additional data are preferably exchanged singly or repeatedly between the portable and the external computation unit, particularly preferably transmitted by the portable to the external computation unit. These data contain information about the execution status of the portable and/or the external computation unit. The execution status of the portable and/or the external computation unit is preferably approximated by way of the additional data.

The emulated user interface is preferably the graphical output that is produced by the emulation. The emulated user interface preferably shows the same graphical elements, program windows and/or menus as the graphical user interface of the portable computation unit. It is preferably similar in its graphical design, particularly preferably identical to the graphical user interface of the portable computation unit. The production of an emulated user interface takes place preferably automatically through the emulation of the operating system of the portable computation unit, as this preferably represents a function of the emulation environment. The emulated user interface preferably consists only of a selection of the graphical elements of the graphical user interface of the portable computation unit (e.g. the emulated user interface consists only of the window that displays a video playing just then).

For the transmission of the emulated user interface in the form of graphics data, these graphics data are preferably generated by the emulation environment. Alternatively, the emulated user interface is displayed on the graphical user interface of the external computation unit and the graphical user interface of the external computation unit is transmitted. In the first case, the transmission of directly generated graphics data takes place to the external display unit, in the second case a transmission of indirectly generated graphics data of the emulated user interface.

The graphics data preferably contain all the required information to display a graphical user interface on the external display unit. The graphics data preferably contain only the information regarding changes of the emulated user interface between temporally different states (transmission of difference images). An image compression, coding and/or transmission method that is respectively currently common and/or efficient is preferably used.

The display of the emulated user interface on the external display unit is preferably the production of an image on the external display unit, wherein the image corresponds to the emulated user interface. Upon display of the emulated user interface, the necessary information is preferably read from the graphics data and the physical pixels of the display unit are activated according to this information.

In this way it is preferably possible to create a substantially identical copy of the operating system that is executed on a portable computation unit on an external computation system and to display the graphical output that is generated by the emulated operating system running in parallel on a further (larger) external display unit. By the transmission of the user inputs to the portable computation unit, preferably both the emulated operating system and the operating system being executed on the portable computation unit are kept in substantially identical execution statuses at runtime. One advantage of the emulation, for example, is that in spite of the display on an external, preferably larger display unit of higher resolution, the speed and fluidity of the program sequences and/or the graphical display are retained, because due to the processors used, the external computation unit preferably has capacity reserves, with the result that the execution of programs and/or the production of graphics data in the emulation is at least at the same speed as, preferably faster than on the portable computation unit. At a higher speed of execution of programs and/or of the production of graphics data in the external computation unit, the time delays that arise due to data transport via a network are preferably compensated for, as due to the higher speed of the external computation unit, time reserves arise compared with the execution and display status of the portable computation unit.

In a further method according to the invention, the step is additionally executed:
transmission of user-specific data from the portable computation unit (20) to the emulation (70).

User-specific data are e.g.: picture files, music files, e-mails, stored passwords, address and telephone books, data carrier contents, progress profiles (Internet surfing profiles, call profiles), Office documents, etc.

The transmission preferably takes place at times determined automatically or by the user of the portable computation unit and/or by the user or operator of the external computation unit. Determination preferably always takes place if user-specific data on the portable computation unit change or have changed.

In this way, the state of personalization to the user of the portable computation unit is recorded and/or followed up in the emulation also. Preferably the most important, preferably all personal data and information that are available on the portable computation unit are thus also available in the emulation.

In a further method according to the invention, the step is additionally carried out:
establishing whether a resolution and/or an aspect ratio of the emulated user interface (55) and/or of a graphical element (56) of the emulated user interface (55) is unequal to the native resolution and/or the native aspect ratio of the external display unit (20) or values provided by a user and thus the emulated user interface (55) and/or the graphical element (56) does not have the same number of pixels as the external display unit (40) in the picture width or in the picture height or as a whole;

and in the case of a disparity being established, additionally one of the steps is carried out:
adaptation of the resolution and/or the aspect ratio of the emulated user interface (55) and/or of the graphical element (56) to the native resolution and/or the native aspect ratio of the external display unit (40) or to values provided by the user by one- or two-dimensional execution of a method or a combination of methods from the group interpolation, subsampling, cropping, pillarboxing, letterboxing;
production of an emulated user interface (55) of the portable computation unit (20) with the native resolution and/or the native aspect ratio of the external display unit (40) or with values provided by the user.

Establishment is preferably a comparing of the number of pixels and the aspect ratio of the emulated user interface and/or of a graphical element with the native number of pixels and the native aspect ratio of the external display unit. Establishment preferably takes place in the emulation environment or emulation device. The external display unit preferably transmits (preferably at the request of the external computation unit) information, which contains at least details of the native resolution and/or the native aspect ratio of the external display unit. Alternatively, establishment takes place in the external display unit and/or a unit connected upstream of the external display unit (e.g. set-top box) and the result of establishment and/or the resolution and the aspect ratio in which the emulated user interface is desired (either by determination of the user or on account of the native resolution and/or the native aspect ratio of the external display unit) are transmitted to the emulation. The emulation then preferably produces an emulated user interface that corresponds to these graphical requirements.

It is preferably established whether the aspect ratio and/or the resolution of the emulated user interface and/or of a graphical element are smaller than the native resolution and/or the native aspect ratio of the external display unit or values provided by a user. Accordingly it is preferably established whether the emulated user interface and/or the graphical program element has fewer picture elements than the external display unit.

Values provided by the user preferably include an indication of the number of the resolution (e.g. picture elements in width and height) and/or of a desired aspect ratio. The user preferably sets such values via the portable computation unit and/or the external display device and/or via a further unit connected upstream of the external display unit.

Adaptation is preferably a step that prepares an existing user interface for display on a display unit that natively has a different resolution and a different aspect ratio than those of the user interface.

In interpolation, intermediate pixels with colour and/or intensity values that depend on the image pixels surrounding them are preferably inserted. In pillarboxing, black (or differently coloured) bars are preferably placed to the right and left of the image, and in letterboxing above and below the image. The methods just mentioned are preferably used for displaying and for adapting a user interface on the external display unit if the emulated user interface has a smaller number of picture elements than the physical picture elements of the external display unit. In subsampling, only every second pixel, for example, is used to generate a new image. This new image then only has half of the picture elements. In cropping, border pixels are preferably cut off. These two methods just named are preferably used if the emulated user interface has more pixels than the native resolution of the external display unit. These methods are sufficiently known to the person skilled in the art.

In a further method according to the invention, in production of the emulated user interface (55), the emulated user interface (55) is produced already with the resolution and the aspect ratio that are equal to the native resolution and the native aspect ratio of the external display unit (40) or equal to values provided by the user, and thus the emulated user interface (55) has as many picture elements in the picture width and picture height as the number of picture elements that can be displayed by the external display unit (40).

In a further method according to the invention, the steps are additionally carried out:
searching on the Internet and/or in software sources (600) provided for this for a program version for a program that is available on the portable computation unit (20), and
using the program version found in the emulation (70),

wherein the program version is designed for a resolution and an aspect ratio that utilise the native resolution and the native aspect ratio of the external display unit (40), in that the respective program version generates at least one graphical element (56) that has at least as many picture elements in the picture width and picture height as the number of picture elements that can be displayed by the external display unit (40).

Programs that are available on the portable computation unit are preferably so-called apps. The searching is preferably carried out by the external computation unit, and there preferably by the emulation environment.

The software sources are preferably made available on a data carrier and/or a certain server on the Internet.

In a further method according to the invention, the steps are additionally carried out:
input of user inputs (80′) into the external display unit (40) and/or a unit connected upstream of the external display unit,
transmission of the user inputs (80′) into the external display unit (40) and/or the unit connected upstream of the external display unit to the emulation (70) and preferably to the portable computation unit (20) and
interpretation of the user inputs (80′) in the emulation (70) and/or preferably in the portable computation unit (20).

User inputs into the external display unit and/or a unit connected upstream of the external display unit are e.g. inputs with a remote control, inputs via touch sensors (e.g. a touch-sensitive touch display) in the external display unit, taking of pictures with a camera integrated into the external display unit, and also types of inputs that were named in connection with user inputs into the portable computation unit and miscellaneous other input options.

The interpretation of the user inputs into the external display unit in the emulation takes place preferably parallel to the interpretation of the user inputs into the portable computation unit in the emulation. Preferably either the user inputs into the external display unit or the user inputs into the portable computation unit are prioritized for interpretation. By interpretation of the user inputs into the external display unit in the portable computation unit, it is preferably possible to control the portable computation unit by input into the external display unit. Here, too, a prioritization of the direct user inputs into the portable computation unit and of the user inputs into the external display unit is preferably undertaken.

In a further method according to the invention, the transmission of the user inputs (80, 80′) and/or the graphics data (50) takes place at least partly via radio (90).

The following, for example, are preferably possible as radio technology: W-LAN, Bluetooth, analog wireless transmission, ZigBee, Infrared, UMTS, GSM, GPRS etc.

In a further method according to the invention, the transmission of the user inputs (80, 80′) and/or the transmission of the graphics data (50) takes place at least partly via a network (120), preferably a cable television network (120′).

Furthermore, a home network and/or the Internet are preferred as a network. For example, the portable computation unit communicates via a home WLAN with a home WLAN router and this home WLAN router communicates with an external computation unit configured as a set-top box or with a set-top box, which communicates via a further network (Internet and/or cable television network) with an external computation unit configured as server.

In a further method according to the invention, in addition to a previous method the step is carried out:
combining the emulated user interface with graphical elements of at least one other source, which generates graphical outputs.

Another source that generates graphical outputs is for example one of the group: TV receiver, video recorder, DVD player (these produce analog/digital graphics data for a video image), desktop computer, multimedia centre (these produce e.g. also their own user interfaces).

The combining is preferably an arranging of the emulated user interface and the graphical output of another source/other sources on the display area of the external display unit and includes particularly preferably at least one action from the following group, wherein the actions are carried out with reference to the emulated user interface and/or the graphical output of the other source(s): enlarging and/or reducing, moving, placing on top of one another or superposing, rotating, mirroring, setting transparency, aligning to a grid.

The step of combining takes place preferably in the external computation unit, preferably in a unit configured as a set-top box, which communicates with the external computation unit.

It is possible in this way to combine the graphical display of various media together with the display of the emulated user interface. For example, a user can then send an e-mail with his smartphone and has the processing window displayed large (in comparison to the direct display of the smartphone) on the external display unit, while other contents such as a television broadcast, for example, are also displayed on the external display unit at the same time.

In a further method according to the invention, a portion or the totality of the method steps described hitherto is carried out additionally for the display of the user interface of at least one further portable computation unit (20.1) on the external display unit (40) and/or one further external display unit (40.1), in that at least the steps are carried out
emulation of the operating system of the portable computation unit (20.1) on the external computation unit (60) in a further emulation (70.1);
input of further user inputs (80.1) into the portable computation unit (20.1);
transmission of the user inputs (80.1) to the emulation (70.1);
interpretation of the user inputs (80.1) in the emulation (70.1);
production of a further emulated user interface (55.1) of the portable computation unit (20.1);
transmission of the emulated user interface (55.1) in the form of further graphics data (50.1) to the external display unit (40 and/or 40.1);
display of the emulated user interface (55.1) on the external display unit (40 and/or 40.1).

The user interfaces of a plurality of different portable computation units are thus preferably displayed on the same external display unit and/or on a further external display unit. The display preferably takes place on the same external display unit according to a priority and/or a manual or automatic switchover. For example, in the case of non-activity of a smartphone, its user interface is no longer displayed and the user interface of another active smartphone is then displayed instead of that of the non-active smartphone. The emulation preferably takes place in a further emulation on a central server. This preferably communicates via network interfaces with various units connected upstream of the external display units, which units have the necessary interfaces according to the invention (e.g. set-top boxes with network interface, input interface for user inputs into a portable computation unit, graphical interface).

The object is achieved, furthermore, by an apparatus for displaying a graphical user interface of a portable computation unit (20) on an external display unit (40), comprising

a) an external computation unit (60) with an emulation device (700), wherein the emulation device (700)
has program code for the emulation (70) of an operating system of the portable computation unit (20),
has a device (720) for forwarding user inputs (80) into the portable computation unit (20) from an input interface (800) to the emulation (70),
has a device (740) for forwarding graphics data (50) for an emulated user interface (55) of the portable computation unit (20) from the emulation (70) to a graphical interface (500)

and wherein in the emulation (70)
the user inputs (80) can be interpreted,
the graphics data (50) can be produced for an emulated user interface (55) of the portable computation unit (20);

furthermore comprising

b) the input interface (800) for transmission of the user inputs (80) from the portable computation unit (20) to the emulation (70);

furthermore comprising

c) the graphical interface (500) for transmission of the graphics data (50) from the emulation (70) to the external display unit (40).

The emulation device is preferably a device in which an operating system can be emulated without the hardware of the unit for which this operating system is designed having to be physically present for this. An emulation device is e.g. an emulation environment, which is offered by various software manufacturers (e.g. VMWare, VirtualBox, etc.). It is preferably set up to execute several emulations.

The program code for the emulation of an operating system of the portable computation unit is preferably a copy of the operating system program code, which is also available on the portable computation unit.

A device for forwarding user inputs into the portable computation unit preferably represents an interface, which permits the transfer of user inputs from outside into the emulation. This device is particularly preferably a software interface, which is provided in the emulation environment.

The input interface is preferably set up to receive inputs into the portable computation unit. The input interface is preferably arranged in the external computation unit, particularly preferably in a unit (e.g. set-top box) connected upstream of the external display unit.

The device for forwarding graphics data is preferably set up to receive graphics data from the emulation and to forward these to a graphical interface. This device is particularly preferably a software interface that is provided in the emulation environment.

The graphical interface is preferably set up to receive the graphics data from the emulation. The graphical interface preferably converts the graphics data into a format that is readable for the external display unit.

User inputs are preferably interpretable if the emulation recognizes the user inputs and can thereupon execute actions or carry out functions that are intended with these user inputs.

The emulation device is preferably set up to produce graphics data in interaction with the emulation and particularly preferably to forward these graphics data in a utilisable form for a graphical interface (e.g. graphics card). It is particularly preferable if the emulation device is set up to display the emulated user interface on the user interface of the operating system of the external computation unit.

In a further practical example of the present invention, the portable computation unit (20) is a smartphone, a tablet computer or a personal digital assistant (PDA).

In a further practical example of the present invention, the apparatus has
an input interface (800′) for transmitting user inputs (80′) into the external display unit (40) and/or into a unit connected upstream of the external display unit from the external display unit (40) and/or from the unit connected upstream of the external display unit to the emulation (70) and/or to the portable computation unit (20) and the emulation device (700) has
a device (760) for forwarding the user inputs (80′) into the external display unit (40) and/or into the unit connected upstream of the external display unit from the input interface (800′) to the emulation (70).

The input interface for transmitting user inputs into the external display unit and/or into a unit connected upstream of the external display unit from the external display unit to the emulation is preferably set up to receive user inputs from the direction of the external display unit and forward these to the emulation and/or preferably via the input interface for transmitting user inputs into a portable computation unit to the portable computation unit. Due to this input interface, the emulation can also be controlled by user inputs into the external display unit and/or the portable computation unit can be controlled by user inputs into the external display unit. The input interface is preferably arranged in the external computation unit, particularly preferably in a unit (e.g. set-top box) connected upstream of the external display unit. The input interface is preferably set up to transmit other user inputs, alternatively or additionally to user inputs into the external display unit, to the emulation and/or to the portable computation unit. The other user inputs preferably originate from an input unit (e.g. wireless mouse, wireless keyboard, IR/wireless remote control) connected directly to the unit connected upstream. The unit connected upstream of the external display unit is e.g. a set-top box, in which input, graphical and/or network interfaces of the apparatus are integrated. It is preferably connected upstream of the external display unit via a graphical interface.

The device for forwarding user inputs into the external display unit from the input interface to an emulation is preferably an interface implemented in software, which is integrated into the emulation environment.

In a further practical example of the present invention, the apparatus has a radio device (100), which is set up to transmit the user inputs (80, 80′) and/or the graphics data (50).

The radio device is preferably set up for wireless communication with the portable computation unit and/or with the external display unit, particularly preferably for the replacement of wired communication between the various interfaces used in the apparatus.

In a further practical example of the present invention, the apparatus additionally has at least two network interfaces (1200) and the external computation unit (60) is spatially separated from the input interfaces (800, 800′) present and the graphical interface (500) and is connected to these via a network (120), preferably a cable network, and via the network interfaces (1200).

A network interface is preferably a network card with Ethernet connection, particularly a network card for wireless transmission (e.g. W-LAN), quite particularly preferably a network interface especially for a coaxial cable network (e.g. network interface for television cable).

The external computation unit is preferably located in another room, quite preferably in another building than the input interfaces present and the graphical interface, particularly preferably in a node or end point of a cable network (e.g. head-end station). Furthermore, it is also preferable that the external computation unit is located in a central server room.

One or more of the components graphical interface, present input interfaces, network interfaces and radio device are preferably at least partly integrated in a set-top box, preferably in the external display unit.

In a further practical example of the present invention, the apparatus has, in addition to the apparatus features previously named, media sources and/or interfaces for other media sources, which preferably produce graphics data. For example, the set-top box has a TV receiver and/or an additional video input and/or a computation unit, which is set up to manage various media and generates its own user interface, wherein in the last-named user interface the graphical outputs of various media sources can preferably be displayed combined.

In a further practical example of the present invention and/or in a further method according to the invention, the user inputs (80, 80′) represent data from at least
a touch sensor, preferably a touch-sensitive screen and/or
a temperature sensor and/or
a position sensor and/or
an acceleration sensor and/or
a camera module and/or
a keyboard and/or
a computer mouse and/or
a microphone module and/or
from a peripheral connectable to the portable computation unit (20) and/or to the external display unit (40) and/or to the unit connected upstream of the external display unit (40).

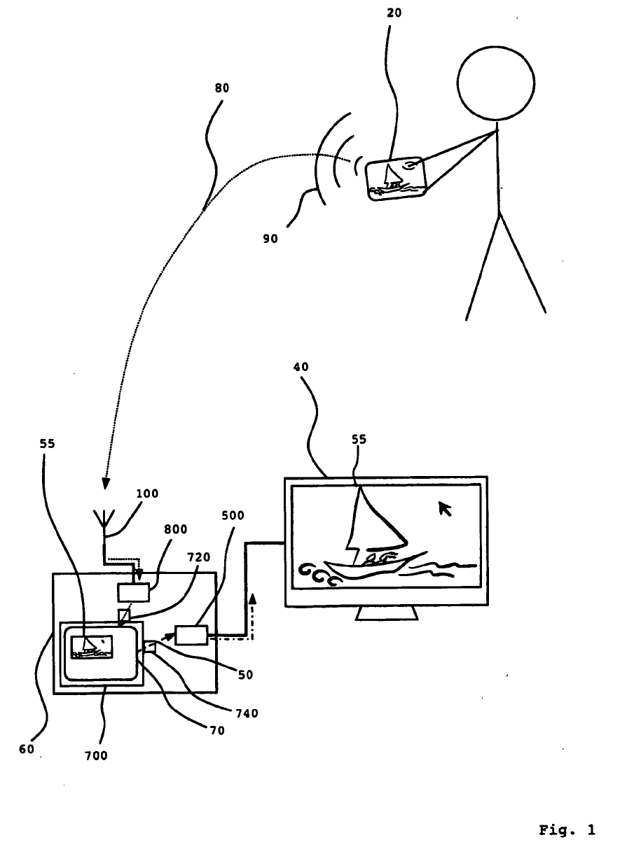

FIG. 1 shows an overview and visualization of the method according to the invention as well as of the apparatus, wherein the graphical user interface of a smartphone 20 is displayed enlarged on a television unit 40 as an external display unit. It shows a user, who is operating a smartphone 20. An external computation unit 60 serves as host computer (computer on which an emulation 70 is executed). The external computation unit 60 in this case is a normal desktop computer. It also has an emulation device 700, in this example a virtualization environment or virtualization software. Located within this software is a virtual machine with the related operating system. The virtual machine and the related operating system in the state executed form the emulation 70. This produces an emulated graphical user interface 55. The emulation software 700 has two interfaces 720 and 740. The interface 720 is a device for forwarding user inputs 80 into the smartphone 20 to the emulation 70. The interface 740 is a device for forwarding graphics data 50 from the emulation 70 to the graphical interface 500. The external computation unit 60 also has an input interface 800. This is connected to a radio device 100. Furthermore, the external computation unit 60 has a graphical interface 500, this graphical interface is set up to receive graphics data 50 from the emulation via the interface 740 and to forward these to a graphical output. The external display unit 40 is connected to this graphical output. The emulated user interface 55 of the smartphone is displayed enlarged on the external display unit 40.

In operation of the apparatus, the user operates the smartphone 20. The user inputs 80, which are registered in operation by the smartphone 20, are transmitted by radio 90 to the radio device 100. They are received there and forwarded to the input interface 800. This transmits these user inputs 80 via the interface 720 to the emulation 70. In the emulation 70, these user inputs are evaluated and commands (such as e.g. mouse pointer movements, the opening of programs, etc.), which the user has carried out on the smartphone 20, are also carried out in the emulation 70. The emulation 70 produces the graphics data 50 of the emulated user interface 55 and forwards these via the interface 740 to the graphical interface 500. The graphical interface 500 prepares these graphics data 50 for the display unit 40. Following specific data preprocessing for the display unit 40 that has further taken place in this unit, an emulated user interface 55 is displayed from the graphics data 50. In this example, an additional visualization of the user inputs 80 also takes place, in that operation via the touchpad function of the smartphone 20 is visualized in the emulation 70 by a mouse pointer and this can be seen accordingly on the emulated user interface 55 also. The user interface 55 is enlarged by interpolation. Alternatively, an emulated graphical user interface 55 is generated in the emulation 70 with a resolution and an aspect ratio that correspond to the native resolution and the native aspect ratio of the external display unit 40.

In this way the user can view an enlarged and if applicable even more highly resolved version of the user interface of his smartphone on the external display unit 40 at the same time as the visual output of the smartphone 20. Furthermore, this has the advantage that not only he, but also several users at the same time, can comfortably follow what is going on on the smartphone 20, thus e.g. the playing of a film or video clip.

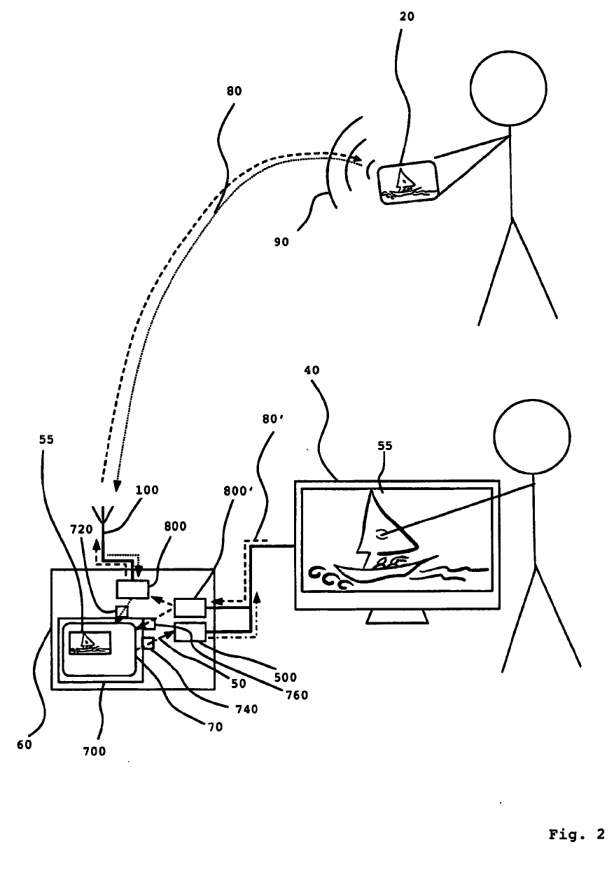

FIG. 2 shows an overview and visualization of the method according to the invention as well as of the apparatus, wherein a user makes user inputs 80′ into the external display unit 40 and these control both the emulation 70 and the portable computation unit 20. In contrast to FIG. 1, the external computation unit 60 is a set-top box. The external computation unit 60 also has an input interface 800′. This is set up to receive user inputs 80′ into the external display unit 40 and forward them via an interface 760 to the emulation 70 and to the input interface 800. The interface 760 is a device for forwarding user inputs 80′ into the external display unit 40 to the emulation 70. In this case, the input interface 800 is also set up in addition to receive user inputs 80′ and forward them to the smartphone 20. In this case the forwarding takes place in addition via the radio device 100 by radio 90.

In operation of the apparatus, the same or another user can now make user inputs 80′ via the external display unit 40. These user inputs 80′ are then forwarded to the input interface 800′, this forwards them in turn via the interface 760 to the emulation 70. There these user inputs 80′ instigate actions or program calls etc. in the same way as user inputs 80. Furthermore, the user inputs 80′ are also forwarded to the input interface 800, which forwards the user inputs 80′ in turn to the smartphone 20. The user inputs 80′ are recognized in the smartphone 20 and functions and actions are carried out there also on account of the user inputs 80′.

In this way a user with a suitable display unit 40 can even control his smartphone 20 “externally” or control it remotely. Several users can also work cooperatively at the same time, however. To prevent undesirable external control, corresponding priority rights and/or control permissions can be modified.

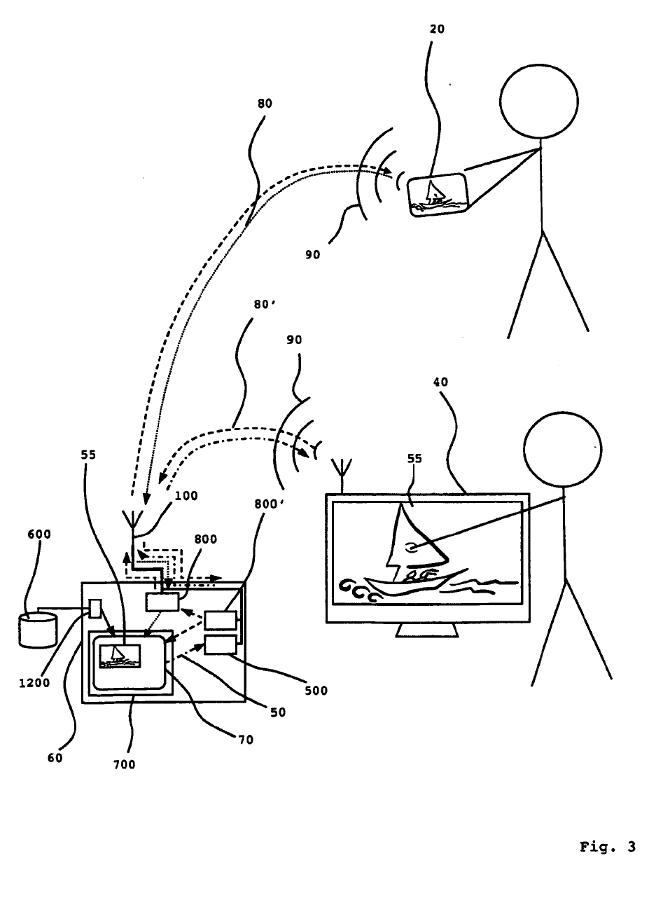

FIG. 3 shows an overview and visualization similar to that in FIG. 2 with the difference that wireless communication is used between the external display unit 40 and the external computation unit 60 and in addition the external computation unit 60 is connected to a software source 600. In this figure, the external display unit 40 is connected by radio 90 to the external computation unit 60 via the radio device 100. The interfaces 720, 740 and 760 are not mentioned again here for reasons of clarity. Furthermore, a software source 600 is connected to the external computation unit. This is a USB hard disk drive in this case. On the USB drive are programs for the smartphone 20 in versions that deliver a resolution and an aspect ratio that correspond to the native aspect ratio and the native resolution of the external display unit 40.

In operation of the apparatus, the emulation device 700 searches on the hard disk 600 for program versions that offer a resolution and/or an aspect ratio that are greater than those of the user interface of the smartphone 20. Ideally, the emulation device 700 finds a program version that generates graphical elements 56 which have a resolution and an aspect ratio that correspond to the native resolution and the native aspect ratio of the external display unit 40. Otherwise the best possible (most highly resolved) version is selected. If the user of the smartphone 20 or the user at the external display unit 40 wishes to open a program, this selected program version is opened. In order to display the graphical user interface 55 large on the external display unit 40 in spite of the optimal program version not being detectable, the emulated user interface 55 is interpolated. The interpolation is carried out by the emulation device 700, the graphical interface 500, or by the display unit 40 itself. Furthermore, the graphics data 50 and the user inputs 80′ into the external display unit 40 are transmitted by radio to the external computation unit 60.

Programs for which more highly resolved versions exist can be selected and displayed automatically in this way and the programs do not have to be already installed in the more highly resolved version on the smartphone 20.

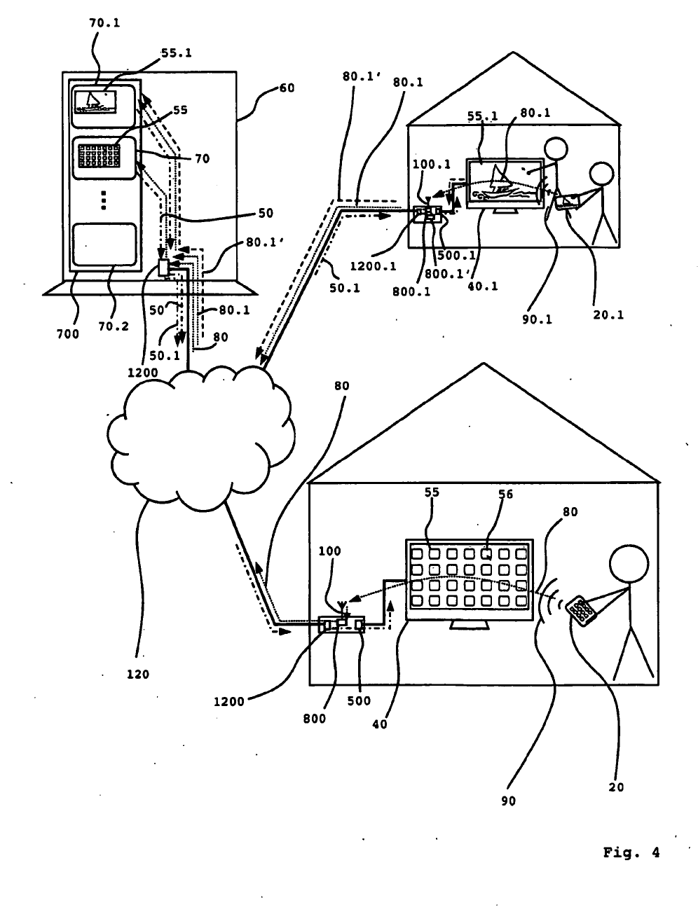

FIG. 4 shows an overview and visualization similar to that of FIG. 3, wherein the input interfaces 800, 800′, the radio device 100 and the graphical interface 500 are spatially separated from the external computation unit 60 and communicate with and are connected to the external computation unit 60 via network interfaces 1200, and wherein the operating system of a further portable computation unit 20.1 is emulated and displayed. A network interface 1200, the input interface 800, the graphical interface 500 and the radio device 100 form a set-top box in this case, which is connected to the external display unit 40 by a cable for graphics data 50. The same components exist also for the emulation 70.1 of the further computation unit 20.1 and are each identified by an additional “0.1” after the reference number. A coaxial cable television network 120 and parts of the Internet lie between the external computation unit 60 and the set-top boxes. In this case the external computation unit 60 is equipped with an emulation device 700, in which several emulations 70, 70.1, 70.2 can be executed. The graphics data 50, 50.1, which can be generated with these various emulations, can be sent to each known external display unit 40, 40.1.

In operation of the apparatus, the users operate the smartphones 20, 20.1 and the external display unit 40.1 and the user inputs 80, 80.1, 80.1′ are transmitted to the set-top boxes. The set-top boxes recognise with reference to the user inputs 80, 80.1, 80.1′ the type of portable computation unit 20, 20.1 and also transmit this type to the external computation unit 60. Various emulations 70, 70.1, 70.2 are executed in the external computation unit. The external computation unit 60 recognizes with reference to the type which emulation 70, 70.1, 70.2 is assigned to this portable computation unit 20, 20.1 and forwards these user inputs 80, 80.1, 80.1′ to the corresponding emulation 70, 70.1. The graphics data 50, 50.1 are thus transmitted to the set-top box from which the user inputs 80, 80.1, 80.1′ were received.

Not portrayed, but also in accordance with the invention, is the case of a user of a further portable computation unit 20.2, who wishes to use the same display unit 40 for display as the user of the portable computation unit 20 and enters user inputs 80.2 into his portable computation unit 20.2. The user inputs 80.2 are also received by the same set-top box (in FIG. 4 the lower set-top box) and forwarded to the external computation unit 60. The set-top box recognizes the type of portable computation unit 20.2 in turn and transmits this information to the external computation unit 60. There these user inputs 80.2 are then forwarded to another emulation, to be precise to the emulation 70.2, which is implemented for the other portable computation unit 20.2 on the external computation unit 60. The graphics data 50.2 are then transmitted in turn to the same set-top box from which the user inputs were received. Alternatively, which portable computation unit 20 is to be displayed on the external display unit 40 can also be set on the set-top box. The set-top box then reacts only to user inputs 80 from this selected portable computation unit 20.

In this embodiment shown by way of example, the aspect ratio of the user interface of the smartphone 20 is also changed in the emulation 70, with the result that the emulated user interface 55 has the aspect ratio of the external display unit 40.

A plurality of different portable computation units 20, 20.1, 20.2 can be used in this way with the apparatus, because an emulation 70, 70.1, 70.2 is executed in the computation unit 60 designed as server for each different (even personalized) portable computation unit 20, 20.1, 20.2. In addition, a plurality of households in which at least one such set-top box is connected respectively can be served with the option of an enlarged display using this central server. A user could then even use the external display unit 40 at his neighbour's house, because the data are rerouted accordingly.

With the invention a method and an apparatus are provided that make it possible to display the user interface of a portable computation unit on a larger external display unit. By using an emulation that has the execution status and preferably also the personal data from the portable computation unit by synchronization, an entirely novel and inventive path has been followed in this case. Due to the virtualization of the portable computation unit on an external computation unit, a high compatibility with many different portable computation units is achieved, because on account of the virtualization, the hardware of the external computation unit does not necessarily have to be consistent with the portable computation unit. For performance reasons, it is advantageous, however, to adapt the hardware of the external computation unit to the hardware of the portable computation unit, with the result that increasingly fewer hardware components have to be virtualized and thus the emulation becomes increasingly a parallel, direct execution of the operating system of the portable computation unit on the external computation unit. The use of emulations also offers the advantage that a plurality of different units can even be emulated simultaneously in parallel on the external computation unit and thus the external computation unit acts as a central server for different users with different portable computation units. This centralization is preferably strengthened via the Internet, in that users in different households or locations use this one computation unit (or a computation cluster) to virtualise their portable computation unit. What is also particularly advantageous about this invention is that the possibility is created by the emulation of recalculating and/or enlarging the graphical user interface for the external display unit, with the result that the native resolution and the native aspect ratio of the external display unit can be exploited optimally. This is also supported by the possibility of the external computation unit searching autonomously for program versions that offer a higher resolution. Moreover, due to the possibility of forwarding user inputs to the emulation and/or the portable computation unit also via the external display unit and of carrying out actions there in each case, an unprecedented flexibility of use of a portable computation unit is attained and cooperation facilitated between several users. In addition, more computing power is available on account of the external computation unit, which power can also be used flexibly.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

### REFERENCE NUMBERS

20 Portable computation unit
40 External display unit
50 Graphics data for an emulated user interface of the portable computation unit
55 Emulated user interface
56 Graphical element
60 External computation unit
70 Emulation
80, 80′ User inputs
90 Radio
100 Radio device
120 Network
500 Graphical interface
600 Software source
700 Emulation device
720 Device for forwarding user inputs 80 into the portable computation unit to the emulation
740 Device for forwarding graphics data to a graphical interface
760 Device for forwarding user inputs 80′ into the external display unit and/or a unit connected upstream of the external display unit to the emulation
800, 800′ Input interface
1200 Network interface

1-15. (canceled)

16. A method for displaying a graphical user interface of a portable computation unit on an external display unit, which has a native resolution and a native aspect ratio, the method comprising:
emulating an operating system of the portable computation unit on an external computation unit in an emulation;
receiving an input of user inputs into the portable computation unit;
transmitting of the user inputs to the emulation;
interpreting the user inputs in the emulation;
producing an emulated user interface of the portable computation unit;
transmitting the emulated user interface in the form of graphics data to the external display unit;
displaying the emulated user interface on the external display unit.

17. The method recited in claim 16, further comprising transmitting user-specific data from the portable computation unit to the emulation.

18. The method recited in claim 16, further comprising:
establishing whether at least one of a resolution or an aspect ratio of at least one of the emulated user interface or of a graphical element of the emulated user interface is unequal to at least one of a native resolution or a native aspect ratio of the external display unit or values provided by a user such that the emulated user interface or graphical element does not have a same number of picture elements in a width of the picture or in a height of the picture or as a whole as the external display unit;
and wherein, in the case of an established disparity, further comprising one of:
adapting at least one of the resolution or the aspect ratio of the emulated user interface or of the graphical element to at least one of the native resolution or the native aspect ratio of the external display unit or to values provided by the user by one- or two-dimensional implementation of a method or a combination of methods from the group including interpolation, subsampling, cropping, pillarboxing, and letterboxing; and
producing an emulated user interface of the portable computation unit with at least one of the native resolution or the native aspect ratio of the external display unit or with values provided by the user.

19. The method recited in claim 16,
wherein upon production of the emulated user interface, the emulated user interface is already produced with the resolution and the aspect ratio that are equal to the native resolution and the native aspect ratio of the external display unit or equal to values provided by the user, and thus the emulated user interface has as many picture elements in the picture width and the picture height as the number of picture elements that can be displayed by the external display unit.

20. The method recited in claim 16, further comprising:
searching at least one of the Internet or software sources for a program version for a program that is available on the portable computation unit, and
using the program version found in the emulation,
wherein the program version is designed for a resolution and an aspect ratio that utilise the native resolution and the native aspect ratio of the external display unit, in that the respective program version produces at least one graphical element, which has at least as many picture elements in the picture width and the picture height as the number of picture elements that can be displayed with the external display unit.

21. The method recited in claim 16, further comprising:
receiving an input of user inputs into at least one of the external display unit or a unit connected upstream of the external display unit,
transmitting the user inputs into at least one of the external display unit or the unit connected upstream of the external display unit to the emulation, and
interpreting the user inputs in at least one of the emulation or the portable computation unit.

22. The method recited in claim 16,
wherein the transmission of at least one of the user inputs or the graphics data takes place at least partly by radio.

23. The method recited in claim 16,
wherein the transmission of at least one of the user inputs or the transmission of the graphics data takes place at least partly via a network.

24. The method recited in claim 16,
wherein a portion or the totality of the method steps is additionally carried out for the display of the user interface of at least one further portable computation unit on at least one of the external display unit or a further external display unit, the steps comprising
emulating the operating system of the portable computation unit on the external computation unit in a further emulation;
receiving an input of further user inputs into the portable computation unit;
transmitting the user inputs to the emulation;
interpreting the user inputs in the emulation;
producing a further emulated user interface of the portable computation unit;
transmitting the emulated user interface in the form of further graphics data to the external display unit;
displaying the emulated user interface on the external display unit.

25. The method recited in claim 16 wherein the user inputs represent data from at least one of a touch sensor, a temperature sensor, a position sensor, an acceleration sensor, a camera module, a keyboard, a computer mouse, a microphone module or a peripheral connectable to at least one of the portable computation unit, the external display unit, or a unit connected upstream of the external display unit.

26. An apparatus for displaying a graphical user interface of a portable computation unit on an external display unit, the apparatus comprising:
a) an external computation unit with an emulation device, the emulation device including:
program code for the emulation of an operating system of the portable computation unit,
a device for forwarding user inputs into the portable computation unit from an input interface to the emulation,
a device for forwarding graphics data for an emulated user interface of the portable computation unit from the emulation to a graphical interface and wherein in the emulation the user inputs are interpretable and the graphics data for an emulated user interface of the portable computation unit is producible;
b) the input interface for transmission of the user inputs from the portable computation unit to the emulation; and
c) the graphical interface for transmission of the graphics data from the emulation to the external display unit.

27. The apparatus recited in claim 26, wherein the portable computation unit is a smartphone, a tablet computer or a personal digital assistant.

28. The apparatus recited in claim 26, further comprising an input interface for transmission of user inputs into at least one of the external display unit or a unit connected upstream of the external display unit from at least one of the external display unit or the unit connected upstream of the external display unit to at least one of the emulation or to the portable computation unit,
wherein the emulation device includes a device for forwarding the user inputs into at least one of the external display unit or the unit connected upstream of the external display unit from the input interface to the emulation.

29. The apparatus recited in claim 26 further comprising a radio device configured to transmit at least one of the user inputs or the graphics data.

30. The apparatus recited in claim 26 further comprising at least two network interfaces, the external computation unit being spatially separated from the input interfaces present and the graphical interface and is connected to these via a network and via the network interfaces.

31. The apparatus recited in claim 26 wherein the user inputs represent data from at least one of a touch sensor, a temperature sensor, a position sensor, an acceleration sensor, a camera module, a keyboard, a computer mouse, a microphone module or a peripheral connectable to at least one of the portable computation unit, the external display unit, or a unit connected upstream of the external display unit.
